(19) United States
(12) Patent Application Publication
(10) Pub. No.: US 2010/0078947 A1
(43) Pub. Date: Apr. 1, 2010

(54) DOOR HANDLE FOR VEHICLE

(75) Inventors: Sadayuki Makino, Nagoya-shi (JP); Yukinobu Kunimatsu, Toyoake-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/566,052

(22) Filed: Sep. 24, 2009

(30) Foreign Application Priority Data
Sep. 26, 2008 (JP) 2008-248500

(51) Int. Cl. E05B 3/00

(52) U.S. Cl. 292/336.3

(57) ABSTRACT

A door handle for a vehicle includes a base portion adapted to be mounted on the vehicle door, a handle rotation shaft supported by the base portion, an operating handle rotatably held around the handle rotation shaft and having a first engagement portion, and a counter weight having a second engagement portion engaging with the first engagement portion provided at the operating handle and a stopper portion preventing a disengagement between the first engagement portion of the operating handle and the second engagement portion by connecting with the handle rotation shaft.

### CROSS REFERENCE TO RELATED APPLICATIONS

This application is based on and claims priority under 35 U.S.C. §119 to Japanese Patent Application 2008-248500, filed on Sep. 26, 2008, the entire content of which is incorporated herein by reference.

### TECHNICAL HELD

The disclosure relates to a door handle operating when opening a door.

### BACKGROUND

A door handle for a vehicle is operated to unlock a lock device to thereby open a door for a vehicle. Such door handle is applied to many different designs of vehicles or to doors provided at different portions of the vehicle such as a rear portion and a side portion. Thus, the component members are required to standardize whenever possible so as to reduce the manufacturing cost.

A counter weight is mounted on the door handle for preventing a generation of a force to open the door at an operating handle portion when an excessive impact is applied to the vehicle. A weight of the counter weight differs depending on the characteristic of the vehicle and the mounting position of the door handle of the vehicle. Consequently, when a specific equipment such as a riveting device is necessary for assembling the operating handle portions and the counter weights, a great number of combinations of the operation handle portions and the counter weights are generated during the manufacturing process, which leads to a complicated manufacturing control.

In order to reduce the manufacturing control complexity, a structure has been proposed where the counter weight and the operating handle portion are assembled, together with other parts of the door handle, at the final assembling process. Such door handle is disclosed in JP3472181B. According to the door handle disclosed, after the counter weight is inserted to the operating handle portion to engage therewith, an end portion of a spring, which is provided to bias the operating handle portion, is disposed to a predetermined position so as to prevent the engagement between the counter weight and the operation handle portion from releasing.

However, according to the door handle disclosed in JP3472181B, a complicated operating procedure that requires a certain skill is necessary for disposing the end portion of the spring, which has a large biasing force, to the predetermined position so as to prevent the disengagement of the counter weight from the operation handle portion. Further, the end portion of the spring needs to be formed in a complicated shape and the like.

A need thus exists for a door handle for a vehicle which is not susceptible to the drawback mentioned above.

### SUMMARY

According to an aspect of the disclosure, a door handle for a vehicle includes a base portion adapted to be mounted on the vehicle door, a handle rotation shaft supported by the base portion, an operating handle rotatably held around the handle rotation shaft and having a first engagement portion, and a counter weight having a second engagement portion engaging with the first engagement portion provided at the operating handle and a stopper portion preventing a disengagement between the first engagement portion of the operating handle and the second engagement portion by connecting with the handle rotation shaft.

### BRIEF DESCRIPTION OF THE DRAWINGS

The foregoing and additional features and characteristics of the disclosure will become more apparent from the following detailed description considered with the reference to the accompanying drawings, wherein:

FIG. 1 is a rear side view of a vehicle including a door handle according to a first embodiment;

FIG. 2 is a cross sectional view taken along line II-II shown in FIG. 1;

FIG. 3 is a diagram viewed from an arrow III shown in FIG. 2;

FIG. 4 is a diagram viewed from an arrow IV shown in FIG. 2;

FIG. 5 is an exploded perspective partial view of a mounting process of an operating handle and a counter weight according to the embodiment;

FIG. 6 is a cross sectional view taken along line VI-VI shown in FIG. 2;

FIG. 7 is a cross sectional view taken along line VII-VII shown in FIG. 6;

FIG. 8 is a cross sectional view of a counter weight according to a second embodiment.

### DETAILED DESCRIPTION

An embodiment will be explained with reference to the attached drawings.

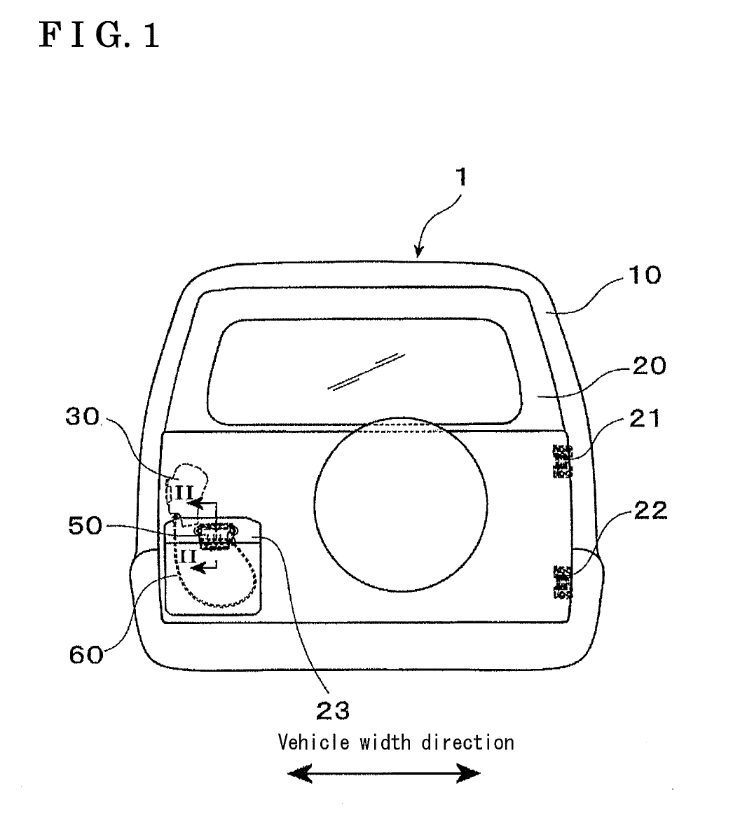

FIG. 1 is a rear side view of a vehicle 1. A back door 20 of the vehicle 1 is mounted on a vehicle body 10. The back door 20 can be opened and closed by means of a first door hinge 21 and a second door hinge 22 provided at upper and lower portions of the vehicle body 10 of FIG. 1.

A door lock device 30 and a door handle 50 are mounted at the back door 20 at a left side of FIG. 1 opposing the first and second door hinges 21 and 22 in a width direction relative to the vehicle 1.

The door lock device 30 engages with a striker, which is mounted on the vehicle body 10, so as to lock the back door 20, thereby keeping the back door 20 closed.

An operation displacement Is transmitted via an interlocking cable 60 to unlock the door lock device 30 when operating the door handle 50. Further, the back door 20 is opened by pulling the door handle 50 in a rearward direction of the vehicle. In addition, the door handle 50 is covered with a garnish 23 which is secured to the back door 20.

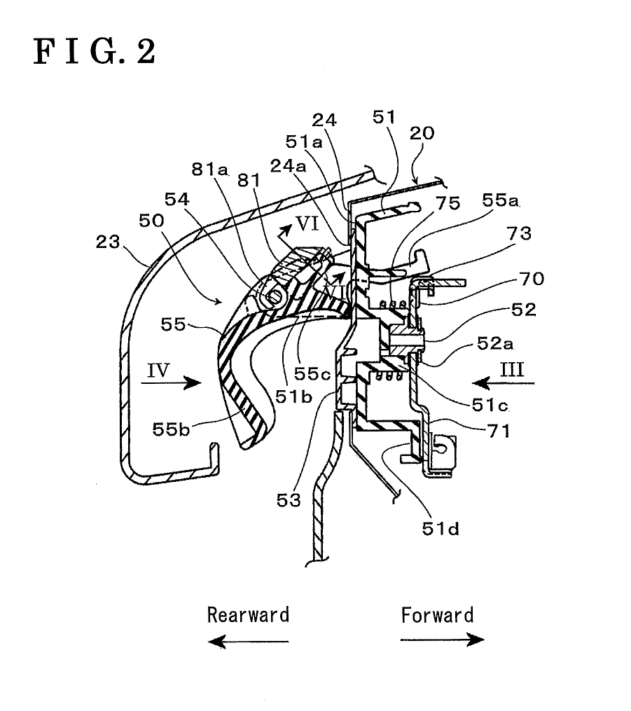

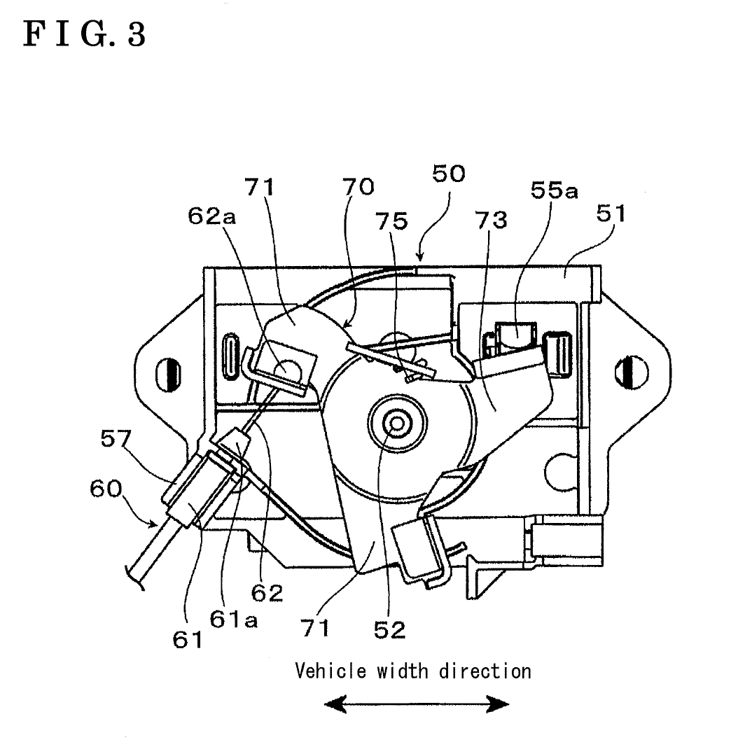

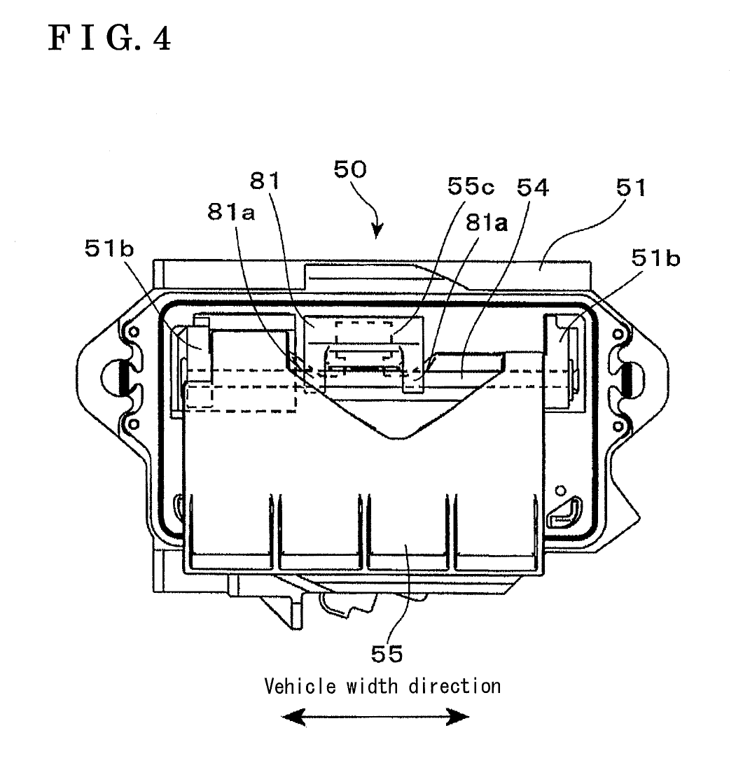

FIG. 2 is a cross sectional view taken along line II-II in FIG. 1. FIG. 3 is viewed from an arrow III in FIG. 2. Further, FIG. 4 is viewed from an arrow IV in FIG. 2.

As shown in FIG. 2, FIG. 3, and FIG. 4, the door handle 50 includes a base portion 51. The base portion 51 includes a mounting surface 51a which is provided along an inner part of a back door panel 24 of the back door 20 (see FIG. 1). A seal member 53 is provided between the mounting surface 51a and the back door panel 24. The back door panel 24 and the mounting surface 51a are fixed to each other through the seal member 53 by means of a screw. The base portion 51 is formed with first and second support arm portions 51b, which extend substantially horizontally in a rearward direction of the vehicle. The first and second support arm portions 51b are penetrating through a window portion 24a, which is provided at the back door panel 24.

The first and second support arm portions 51b are provided at a predetermined space in the width direction of the vehicle. A horizontally extending rotation shaft of the handle (hereinafter referred to as a handle rotation shaft 54) is mounted on the first and second support arm portions 51b so as to serve as a bridge between the first and second support arm portion 51b. An operating handle 55 is provided between the first and second support arm portions 51b and is rotatably held by the handle rotation shaft 54. The operating handle 55 includes an operating portion 55b and an actuator arm 55a. The operating portion 55b extends rearwardly to a lower side of the handle rotation shaft 54. The actuator arm 55a extends horizontally forward on an opposite side from the operating handle 55 relative to the handle rotation shaft 54.

The base portion 51 is formed with a drive shaft portion 51c, which stands upwardly and parallel in a forward direction of the vehicle. Further, a rotation shaft lever 52 is integrally mounted on the drive shaft portion 51c so as to be coaxial therewith. The rotation shaft lever 52 extends in a forward direction of the vehicle. A rotation lever 70 is rotatably held by the rotation shaft lever 52 and is retained by a retainer ring 52a.

As shown in FIG. 3, the rotation lever 70 is provided with two connecting arms 71 and a drive arm 73. The connecting arms 71 and the drive arm 73 extend in a radial direction about the rotation shaft lever 52. The interlocking cable 60 is formed with a cable case 61 and a cable 62 which is guided by the cable case 61. A case end portion 61a of the cable case 61 is secured to a cable case mounting portion 57 which is mounted on the base portion 51. A tip end portion of one of the connecting arms 71 is engaged with a round shaped tip portion 62a which is provided at the cable 62. The other one of the connecting arms 71 is used in a vehicle, having a different design and where the door handle 50 is located at a different position.

As shown in FIG. 2 and FIG. 3, a spring 75 is mounted between the rotation lever 70 and the base portion 51. The spring 75 biases the rotation lever 70 in a counterclockwise direction as viewed in FIG. 3. The actuator arm 55a of the operating handle 55 is in pressured contact with a tip end portion of the drive arm 73 of the rotation lever 70, so as to hold the rotation lever 70 to a predetermined position as shown in FIG. 3.

In the structure explained above, when pulling the operating portion 55b of the door handle 50 in a rearward direction of the vehicle, the actuator arm 55a moves downwardly in FIG. 3 and the rotation lever 70 rotates in a clockwise direction against the biasing force of the spring 75.

Because the rotation lever 70 rotates in the clockwise direction, the tip portion 62a of the cable 62 is pulled away from the case end portion 61a. Then, the other end portion of the cable 62, which is connected to the door lock device 30 is pulled to thereby unlock the door lock device 30.

Next, a counter weight 81, which is a main structure of the present embodiment, will be explained with reference to FIGS. 2, 4 to 7. The counter weight 81 is mounted on the operating handle 55 so as prevent the operating handle 55 from moving and the door lock device 30 from unlocking, resulting from the acceleration that occurs when an excessively large impact is applied to the vehicle 1.

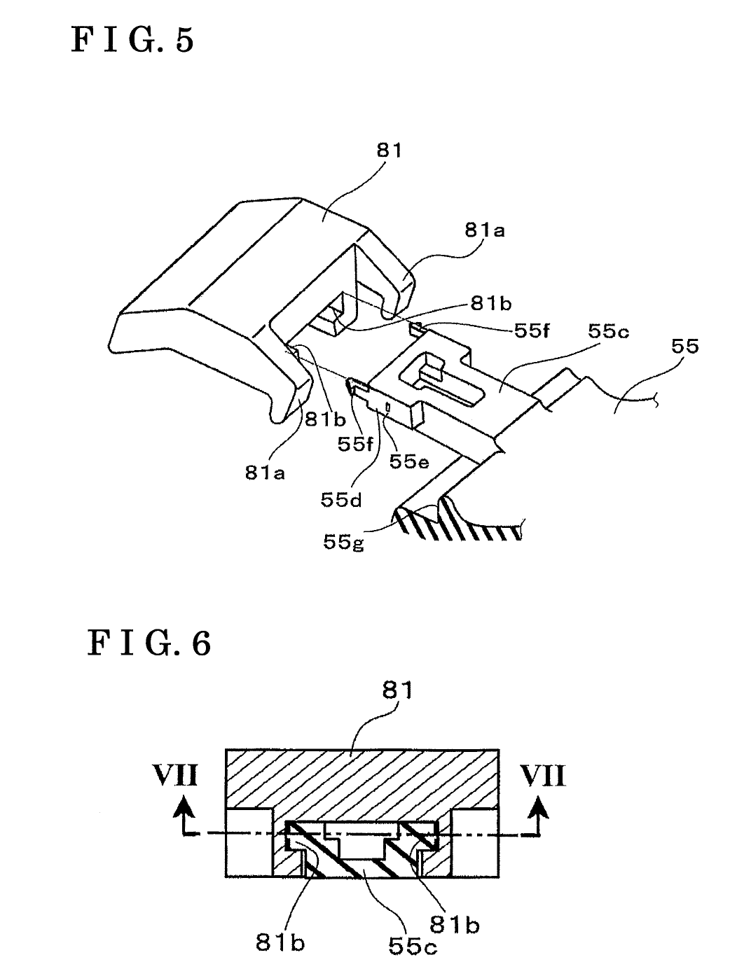

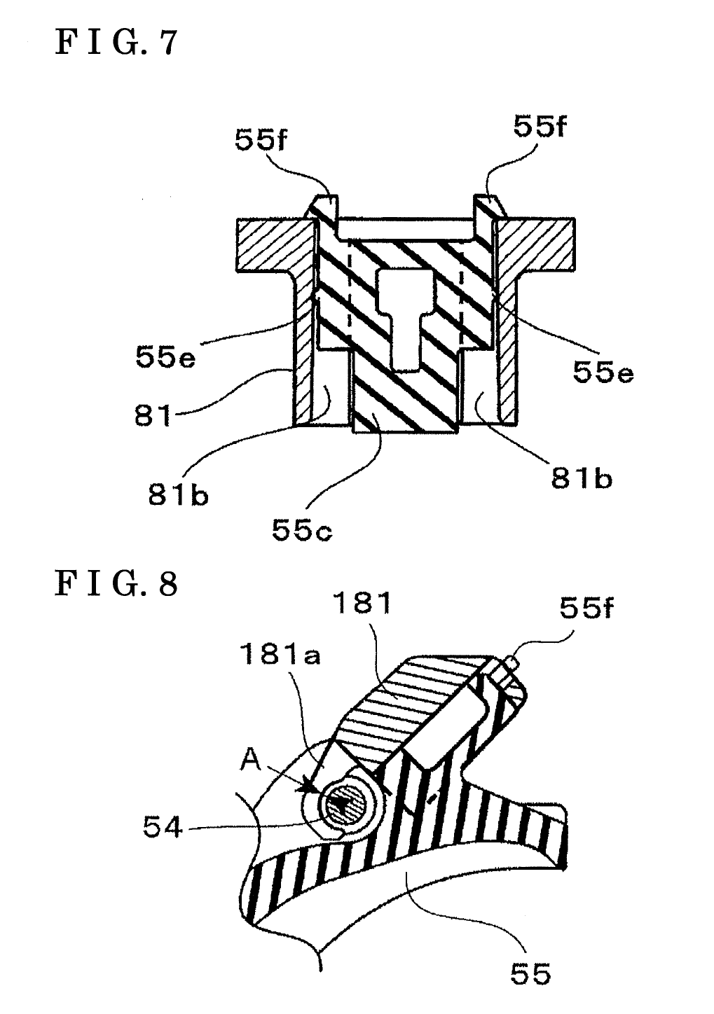

FIG. 5 is an exploded perspective partial view of a mounting process with the operating handle 55 and the counter weight 81. The operating handle 55 is formed with a support protrusion 55c (a first engagement portion) at the middle position in the width direction of the vehicle. The support protrusion 55c extends In an opposite direction from the operating portion 55b relative to the handle rotation shaft 54. In other words, the support protrusion 55c extends substantially in the same direction as the actuator arm 55a. As shown in FIG. 6, the support protrusion 55c has a T shape in cross section, which is perpendicular to the longitudinal direction. As shown in FIG. 5 and FIG. 7, a pair of hook portions 55f (retaining portions) is formed on the handle 55 so as to further protrude in a longitudinal direction from a tip portion of the support protrusion 55c. The counter weight 81 includes two opposing grooves 81b (a second engagement portion). The T-shaped portion of the support projection 55c is inserted to the two grooves 81b to engage therewith so that the counter weight 81 is mounted on the operation handle 55.

When the support protrusion 55c is inserted into the grooves 81b, the elastic deformable hook portions 55f fall to an inside of the grooves 81b and are reformed to an original shape after insertion. Consequently, as shown in FIG. 7, the hook portions 55f hook into the edge surface of the counter weight 81. The operating handle 55 is formed with a contact surface 55g (FIG. 5), which looks one edge surface of each of the grooves 81b. Another edge surface of each of the grooves 81b is depressed by the hook portion 55f. Accordingly, the counter weight 81 is locked without a rattle noise in an inserting direction.

In addition, a side surface 55d of the support protrusion 55c attached to an inner surface of the groove 81b is formed with a small embossed portion 55e (a projecting portion) that slightly projects. Because the embossed portion 55e contacts the inner surface of the groove 81b by a predetermined load, the counter weight 81 is locked without a rattle in a width direction of the support protrusion 55c.

As shown in FIG. 2 and FIG. 5, the counter weight 81 is formed with a stopper portion 81a that extends to the handle rotation shaft 54. A tip portion of the stopper portion 81a hooks with the handle rotation shaft 54 by bending around the handle rotation shaft 54. The stopper portion 81a is formed into a key-shape for preventing the engagement between the counter weight 81 and the support protrusion 55c.

In a structure of the door handle 50 explained above, it is not required to premount to the operating handle 55 to the counter weight 81. The counter weight 81 is not required to be subassembled parts and is assembled with the other parts at the final assembling process.

As shown in FIG. 5, the counter weight 81 is not released from the operating handle 55 because the support protrusion 55c of the operating handle 55 is inserted into the grooves 81b of the counter weight 81 and then the handle rotation shaft 54 is mounted. The handle rotation shaft 54 and the counter weight 81 are generally formed by a material made of steel. Even when an excess impact is applied to the vehicle 1, the counter weight 81 may not be released from the operating handle 55 due to a breakage.

An inserting load that is decided depending on the size of the embossed portion 55e is set to be small within a range where a rattle noise caused by a vibration that occurs in an ordinary usage of the vehicle 1 is prevented between the operating handle 55 and the counter weight 81. Therefore, the counter weight 81 may easily be inserted without requiring specific tools.

FIG. 8 shows a shape of a counter weight 181 according to a second embodiment. A predetermined clearance A is provided between a stopper portion 181a of the counter weight 181 and the handle rotation shaft 54. When an excessive impact is applied to the vehicle 1, the stopper portion 181a contacts the handle rotation shaft 54 so that the counter weight 181 is prevented from disengaging. Under normal operation, the stopper portion 181a and the handle rotation shaft 54 do not contact each other, accordingly, door handle is obtained having a smooth operation.

According to the structure explained above, the counter weights 81 and 181 are flat shaped and formed in a compact shape. The counter weights 81 and 181 may be provided at an outside of the back door 20. Therefore, the other members in the back door 20 and the counter weights 81 and 181 are prevented from interfering with each other thus improving a design freedom.

Even when the door handle 50 is covered with the garnish 23, a leakage may occur at an inside of the back door 20 against the contact force of the seal member 53 while washing a car with a pressure washer and the like. As shown in FIG. 2, a flange portion 51d is formed at the base portion 53 that is provided at the inside of the back door 20. Meanwhile, in the door handle 50 that is designed compactly because the counter weight 81 is arranged at the outside of the back door 20, mechanical parts such as the rotation lever 70 are provided close to the seal member 53. When a leakage occurs at the inside of the back door 20 against the contact force of the seal member 53, the U-shaped flange portion 51d that opens rearwards guides the leaked water and prevents the water from attaching to the mechanical parts. Consequently, functions of the door handle 50 may not be damaged due to a freezing of the mechanical parts, for example.

According to the aforementioned embodiment, the door handle 50 is applied to the back door 20. Alternatively, the door handle 50 is applicable to a side door.

According to the aforementioned embodiment, the engagement between the counter weight 81, 181 and the operating handle 55 is prevented from releasing because the handle rotation shaft 54 is mounted on the door handle 50. Thus, in the process of mounting the counter weight 81, 181, a complicated operating procedure that requires a certain skill is not necessary for preventing the engagement between the counter weight 81, 181 and the operating handle 55 from releasing. Therefore, the manufacturing process of the door handle 50 becomes simple, which leads to an improved productivity.

A projecting portion 55e is formed on either the first engagement portion 55c or the second engagement portion 81b, in a state where the first engagement portion 55c and the second engagement portion 81b are mutually in contact with each other.

Accordingly, the rattle noise caused by a vibration at the engagement portion between the counter weight 81, 181 and the operating handle 55 is prevented.

A retaining portion 55f is formed on either the counter weight 181 or the operating handle 55 for preventing a release of the engagement between the first engagement portion 55c and the second engagement portion 81b and wherein a predetermined space is provided between the stopper portion 181a and the handle rotation shaft 54.

Because the predetermined space A is provided between the stopper portion 181a and the handle rotation shaft 54, a friction is prevented from being generated between the stopper portion 81a and the handle rotation shaft 54. As a result, the excellent operation performance of the door handle may be achieved. In an emergency such as when an excessively large impact is applied to the vehicle, the stopper portion 181a and the handle rotation shaft 54 make contact with each other so that the engagement between the first engagement portion 55c and the second engagement portion 81b is ensured.

The principles, preferred embodiment and mode of operation of the present invention have been described in the foregoing specification. However, the invention which is intended to be protected, is not to be construed as limited to the particular embodiments disclosed. Further, the embodiments described herein are to he regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door handle for a vehicle door, comprising:
a base portion adapted to be mounted on the vehicle door;
a handle rotation shaft supported by the base portion;
an operating handle rotatably held around the handle rotation shaft and having a first engagement portion; and
a counter weight having a second engagement portion engaging with the first engagement portion provided at the operating handle and a stopper portion preventing a disengagement between the first engagement portion of the operating handle and the second engagement portion by connecting with the handle rotation shaft.

2. The door handle according to claim 1, wherein a projecting portion is formed on either the first engagement portion or the second engagement portion, in a state where the first engagement portion and the second engagement portion are mutually in contact with each other.

3. The door handle according to claim 1, wherein a retaining portion is formed on either the counter weight or the operating handle for preventing a release of the engagement between the first engagement portion and the second engagement portion and wherein a predetermined space is provided between the stopper portion and the handle rotation shaft.

4. The door handle according to claim 2, wherein a retaining portion is formed on either the counter weight or the operating handle for preventing a release of the engagement between the first engagement portion and the second engagement portion and wherein a predetermined space is provided between the stopper portion and the handle rotation shaft.
